(19) United States
(12) Patent Application Publication
(10) Pub. No.: US 2004/0134851 A1
(43) Pub. Date: Jul. 15, 2004

(54) Polymeric surface treatment of filter media

(76) Inventors: Jeffrey A. Lucas, Clinton, CT (US); Anna Bailey, Wallingford, CT (US); Eshan B. Yeh, Unionville, CT (US)

Correspondence Address: CUMMINGS & LOCKWOOD, Attn: Anita Lomartra, 700 State Street, Granite Square, P.O. Box 1960, New Haven, CT, 06509-1960, US

(21) Appl. No.: 10/625,921

(22) Filed: Jul. 24, 2003

Related U.S. Application Data
(60) Provisional application No. 60/398,136, filed on Jul. 24, 2002.

(51) Int. Cl. B01D 29/11

(52) U.S. Cl. 210/497.01; 210/506

(57) ABSTRACT

Fluid filtration devices that include nylon membranes are provided according to the present disclosure that maintain thorough wetting of a membrane through the end cap bonding process. The fluid filtration device typically includes a pleated microporous nylon filter media and polypropylene end caps. The pleated microporous filter media is treated with hydrophilic polymeric surface treatments at the ends thereof prior to contact with molten polypropylene end caps, thereby maintaining the ability to integrity test the filtration device in water. Exemplary polymeric surface treatments include solutions and dispersions of polyvinyl alcohol, polyethyleneimine, a combination of 1-4 butanediol diglycidyl ether and ethylene amine, and a quaternary amine polyepichlorohydrin.

### 1. CROSS REFERENCE TO RELATED APPLICATIONS

The present application claims the benefit of a commonly assigned, co-pending provisional patent application entitled “Polymeric Surface Treatment of Filter Media,” filed on Jul. 24, 2002 and assigned Serial No. 60/398,136, the entire contents of which are hereby incorporated by reference.

### BACKGROUND OF THE DISCLOSURE

1. Technical Field

The present disclosure relates to fluid filtration devices and, more particularly, to a method and system for maintaining thorough wetting of a membrane through the end cap bonding process of a membrane filter device. The present disclosure further relates to a pleated filter device that includes a microporous filter media and polypropylene end caps that is integrity testable in water.

2. Background of Related Art

Pleated membrane filter cartridges are well known in the art and typically include a pleated filter element having a plurality of longitudinal pleats arranged in a cylindrical configuration, a perforated cage disposed about the outer periphery of the filter element for admitting fluid into the cartridge, a perforated core coaxially disposed within the filter element, and end caps disposed at each end of the filter element to prevent fluid from passing through the end surfaces of the filter element.

The core generally serves as an inner hollow tube on which the pleated filter element may be supported, conferring strength upon the cartridge assembly and generally determining the final assembly length of the filter cartridge. The core further generally defines the outlet port of the cartridge and filtered fluid generally passes to the outlet of the filter housing through perforations defined therein.

Typically, the core and cage of a pleated filter cartridge are constructed from a polypropylene material based, at least in part, on the fact that polypropylene is relatively inexpensive, easily moldable, effective in bonding to ancillary components (e.g., adapters), and resistant to many fluids, including most solvents. The use of polypropylene in membrane filter constructions is well accepted as a material that provides sufficient strength, cleanliness, and bonding properties in the assembly of membrane filter devices. Other thermomelt polymers, such as polyesters and high density polyethylene, are also used in the fabrication of cores and cages for pleated filter cartridges.

Filtration membranes made of nylon-based polymers are also well accepted as filter media which provide sufficient water wettability, strength, cleanliness and bonding properties. The nylon membrane is typically bonded to end caps fabricated from polypropylene by heating the polypropylene to a molten state and penetrating the ends of the nylon membrane into the molten polypropylene. However, when nylon membranes are bonded to such polypropylene end caps, complete and thorough wetting of the nylon membrane is compromised thereafter. It is believed that compromise of wettability results from hydrophobic constituents in the polypropylene, such as antioxidants, lubrication agents, and possibly low molecular weight oligomers, that become highly mobile at the elevated temperatures associated with the bonding process, and that such hydrophobic constituents migrate to the filtration media. It is anticipated that a similar migration phenomenon would be encountered with other thermomelt polymers containing similar constituents. Polyester materials have exhibited less impact on wettability than polypropylene, and based on the similarities between polypropylene and high density polyethylene, similar impacts on wettability would be anticipated.

Wettability is compromised because the water will not adhere to the hydrophobic surface and is easily cleared from the pores of the media during a pressure test. Poor wettability substantially complicates the use of a filter product, especially in applications where a pharmaceutical manufacturer is attempting to sterilize a product with filtration. In these applications, the manufacturer must verify that the filter they were using (or plan to use) entirely retained all bacteria after the filtration of their batch. This test is commonly performed by thoroughly wetting out the filter with fluid (usually water or the manufacturer's processing fluid, which is frequently water based). The manufacturer then applies a pre-determined pressure against the filter. The pressure required to clear the pores is a function of the pore size of the filter and its surface energy as well as the surface tension of the fluid. If the surface energy of the filter and the surface tension of the fluid are fixed, then the pressure required to clear the pores is a function of the pore size only. If a customer or interested third party (e.g., the FDA) is provided with a correlation of pore size versus pressure, they can then determine if the maximum pore size(s) in the filter element is/are smaller than the smallest bacteria of relevance, and therefore whether the filter logically retained (or will retain) all of the relevant bacteria. As a practical matter, detailed methods for these test methods have been established.

If the surface energy of the filter media is altered due to contaminants on its surface, then the water will not adhere readily and the pores will clear at a substantially lower pressure than would otherwise be the case. In the test application, the result would be a significant increase in airflow through the cartridge and the test reported as a failure. The cartridge may in fact completely retain the relevant bacteria in this type of failure, but for all practical purposes, the customer or interested third party cannot readily verify that it will be retentive because of the confounding and unacceptable test result.

U.S. Pat. No. 5,846,421 to Ohtani describes a microfiltration membrane cartridge filter formed by pleating a porous membrane sheet having a mean pore size of 0.05 to 10 μm. According to the Ohtani '421 patent, the pores in the opposite end portions of the cylindrical membrane are filled up with a high molecular weight polymer to reject the liquid permeation of such opposite end portions. The microfiltration membrane cartridge filter can be made wet to water so that integrity testing can be carried out easily and accurately. The Ohtani '421 patent discloses the use of a hydrophilic material to fill up the membrane pores, e.g., polyvinyl alcohol, vinyl alcohol-ethylene copolymer, polyvinyl pyrrolidone, polyhydroxyethyl acrylate, polyhydroxyethyl methacrylate, polyamide acrylate, etc.; cellulose derivatives such as hydroxyethyl cellulose, hydroxypropyl cellulose, etc.; polymer saccharides such as chitin, chitosan, alginic acid, and gelatin.

Of note, the Ohtani '421 patent's method for filling the end pores with a high molecular weight polymer “plugs” the membrane pores. According to the Ohtani '421 patent, the amount of the high molecular weight polymer required to fill up the membrane pores to thereby reject liquid permeation is at least 1 mg/cm per membrane unit area. Use of an excessive amount of the high molecular weight may cause the membrane to become hard and fragile, and may negatively effect sealing between the membrane and the component referenced by Ohtani as the “end plate,” i.e., the end cap. The Ohtani '421 patent notes that if, not only the pores on the interior of the membrane are filled with the high molecular weight polymer, but also the pores on the surface of the membrane are filled, attention must be given to material selection. In such cases, the Ohtani '421 patent states that it is necessary to select an end plate/end cap material that is capable of effectively adhering to the high molecular weight polymer.

It is also known to improve the wettability in the area of the end cap bond involves film edging, which is accomplished by hot melting a polymer film onto the edge of the membrane prior to the pleating step. U.S. Pat. No. 4,392,958 to Ganzi et al., U.S. Pat. No. 4,512,892 to Ganzi et al., and U.S. Pat. No. 4,906,371 to Miller disclose these processes. Film edging completely blocks the membranes pores and creates a barrier between the end cap and the media. This barrier cuts back on available filtration area. Another difficulty associated with film edging is that it is difficult to track the location of the film edged region(s) during the pleating process. On occasion, the edging is completely trimmed off the end of the pleated piece prior to end capping, which negates the benefit of adding the film edging.

Membrane filters are also manufactured using non-propylene end caps. For example, membrane filter cartridges are fabricated using polyester end caps, which generally eliminates the wettability issue associated with polypropylene end cap products. However, polyester has limited chemical compatibility, and is not compatible with caustic solutions. Thus, depending on potential uses/applications, polyester may not be a viable material choice for end cap manufacture due to such chemical capability limitations. Polyester is also more difficult to melt and must be protected against oxidation during the melt phase. It requires a much higher melt temperature than polypropylene and has a very low viscosity after melt, making it runny and more difficult to control.

Nylon membranes are frequently charge modified to enhance the performance thereof. While the material(s) used to effectuate charge modification of the nylon membrane may have a tendency to improve wettability of the membrane in certain instances, charge modification of the entire width of nylon media may limit the use/applicability of the treated membrane. For example, applications wherein sophisticated protein solutions are filtered may find that a charge modified media undesirably pulls proteins out of the pharmaceutical solution(s).

Thus, despite prior art efforts, it would be beneficial to provide a nylon membrane that maintains thorough wetting when brought into contact with molten polypropylene during the bonding process. It would also be beneficial to provide a pleated filter device that includes a microporous nylon filter media and propylene end caps that is integrity testable in water.

### SUMMARY OF THE DISCLOSURE

According to the present disclosure, advantageous filter cartridge assemblies and methods for manufacture thereof are provided. The filter cartridge assemblies include nylon membranes that maintain thorough wetting through the end cap bonding process. The filter cartridge assemblies typically include a pleated microporous nylon filter media and polypropylene end caps. The pleated microporous filter media is treated with an advantageous hydrophilic polymeric solution or dispersion at the ends thereof prior to contact with molten polypropylene end caps, thereby maintaining the ability to integrity test the filtration device in water.

The disclosed treatment system generally includes a treatment that addresses two criteria. First, the disclosed treatment system advantageously includes an element having a moeity with hydrophilic groups, such as hydroxyl groups (as might be found on polyvinyl alcohol), amine groups (as might be found in ethylene amines; e.g. tetraethylene pentamine) or carboxyl groups. Second, the disclosed treatment system advantageously includes an element having a linkage agent that will couple the first element to the membrane. In terms of addressing wettability, the linking agent is not required, but without the linking agent, the first element will generally wash out of the filter element over time, creating an undesirable extraction. According to the present disclosure, the linking agent is preferably a diepoxide, such as 1-4 butanediol diglycidyl ether.

In a preferred embodiment of the present disclosure, both above-noted criteria are satisfied through a treatment that includes both hydrophilicity, e.g., through the presence of hydroxyl groups, and a linking agent. A presently preferred treatment for satisfying both criteria is Resicart E (Ciba Specialty Chemicals, Basel, Switzerland), but it is anticipated that other polyamine epichlorohydrin (“PAE”) resins could be used to achieve the above-noted criteria. Resicart E is activated with sodium hydroxide (a solution pH of 9.5-12.5 is preferred), but other PAE resins do not require sodium hydroxide activation.

In a preferred embodiment, the Resicart E is prepared in a solution of about three percent (3%) solids with sufficient sodium hydroxide to bring the pH to 9.5-12.5. The end of the filter element, prior to bonding the end caps, is dipped into the treatment solution. The treatment depth is about one quarter to one-half inch from the end and can be conducted conveniently at room temperature. The treatment is then cured by drying, preferably at 80° C. for four hours. Drying at higher temperature to speed the process is possible, but overdrying can cause the loss of wettability. At 80° C., loss of wettability occurs at approximately six hours drying. At higher temperatures, drying time to achieve treatment cure and overdrying which will degrade wettability occur much closer together. It is believed that the loss of wettability is related to the membrane itself and not a failure of the treatment system.

According to the present disclosure, it is anticipated that a treatment that provides both hydrophilicity and a linking agent, as described herein, will be beneficial to any filtration membrane, such as filtration membranes fabricated from nylon and polyethersulfone (PES) and/or polyvinylidene fluoride (PVDF) which will bind to epoxy.

Thus, in an exemplary embodiment of the present disclosure, a filter cartridge assembly is provided that includes a cylindrical filter element that defines an outer periphery, an inner periphery and opposed end surface regions. A hydrophilic polymeric surface treatment is provided on the opposed end surface regions of the filter element. The polymeric surface treatment chemically links to the surface of the filter element in the opposed end surface regions. The filter cartridge assembly further includes polypropylene end caps bonded to the opposed end surface regions of the cylindrical filter element. The filter cartridge assembly is advantageously integrity testable in water. In addition, the hydrophilic polymeric surface treatment does not occlude the pores of the filter element, thereby ensuring optimal filtration performance thereof.

In further exemplary embodiments of the present disclosure, the hydrophilic polymeric surface treatment is effected using a polymeric solution or dispersion that includes a polymeric material typically selected from polyvinyl alcohol, polyethyleneimine, a combination of 1-4 butanediol diglycidyl ether and ethylene amine, and a quaternary amine polyepichlorohydrin. The cylindrical filter element is typically pleated and finds a variety of industrial and clinical filtration applications.

In a further exemplary embodiment of the present disclosure, a method for fabricating an advantageous filter cartridge is provided. The method involves providing a cylindrical filter element that defines an outer periphery, an inner periphery and opposed end surface regions. A hydrophilic polymeric surface treatment is applied to the opposed end surface regions of the filter element. The polymeric surface treatment undergoes cross linking and chemically links to the surface of the filter element in the opposed end surface regions. Polypropylene end caps are bonded to the surface treated opposed end surface regions of the cylindrical filter element. The filter cartridge fabricated according to the disclosed method may be advantageously integrity tested in water.

According to the disclosed exemplary method of fabrication, the hydrophilic polymeric surface treatment may be effected using a polymeric solution or dispersion that includes a polymeric material typically selected from polyvinyl alcohol, polyethyleneimine, a combination of 1-4 butanediol diglycidyl ether and ethylene amine, and a quaternary amine polyepichlorohydrin. The cylindrical filter element may be fabricated from a membrane material such as nylon, polyethersulfone (PES) and/or polyvinylidene fluoride (PVDF), and is typically pleated. Treated membranes according to the present disclosure find utility in a variety of industrial and clinical filtration applications. The filter element is porous and the hydrophilic polymeric surface treatment is non-occlusive with respect to the pores of the filter element. Application of the hydrophilic polymeric surface treatment may be effected by dipping the opposed end surface regions in a hydrophilic polymeric solution or dispersion and curing the hydrophilic polymeric surface treatment.

According to a further exemplary fabrication method of the present disclosure, a filter cartridge element is manufactured by applying a hydrophilic polymeric surface treatment to opposed end surface regions of filter element roll stock. The hydrophilic polymeric surface treatment is cured on the opposed end surface regions, such that the polymeric surface treatment undergoes cross linking and chemically links to the surface of the filter element roll stock in the opposed end surface regions. In an exemplary embodiment, the hydrophilic polymeric surface treatment is applied to limited end regions of the roll stock, e.g., over regions of about one inch from each edge, thereby accommodating edge trimming of about 1/2 inch. In instances where edge trimming is not contemplated/required, a lesser degree of surface treatment may be undertaken, e.g., over a region extending about ½ to ¾ inches from each edge. A cylindrical filter element is formed using the filter element roll stock, with the filter element defining an outer periphery, an inner periphery and opposed end surfaces. The cured hydrophilic polymeric surface treatment is positioned at the opposed end surfaces. Polypropylene end caps are bonded to the opposed end surfaces of the cylindrical filter element; and the filter element may be integrity tested in water.

According to the disclosed exemplary fabrication method, the hydrophilic polymeric surface treatment is typically effected using a polymeric solution or dispersion that includes a polymeric material selected from polyvinyl alcohol, polyethyleneimine, a combination of 1-4 butanediol diglycidyl ether and ethylene amine, and a quaternary amine polyepichlorohydrin. The cylindrical filter element is generally formed by pleating of the filter element roll stock. The filter element is porous and the hydrophilic polymeric surface treatment is advantageously non-occlusive with respect to the porosity of the filter element.

When applying the hydrophilic polymeric surface treatment to roll stock, apparatus such as pinch rollers, slot dies, a sprayer system, and combinations thereof, may be advantageously utilized. The hydrophilic polymeric surface treatment is generally cured by exposing the opposed end surface regions to heat, e.g., using an infrared heater, a convection oven, and combinations thereof.

Additional features and benefits of the disclosed filter cartridge assemblies and methods for fabrication thereof will be apparent from the detailed description which follows.

### BRIEF DESCRIPTION OF THE FIGURES

So that those having ordinary skill in the art to which the subject matter of the present disclosure appertains will more readily understand how to construct and use the disclosed filter cartridge assemblies, reference may be had to the drawings wherein:

FIG. 1 is a perspective view of an exemplary cartridge housing for use with filter cartridge assemblies as disclosed herein; and

FIG. 2 is an exploded perspective view of an exemplary filter cartridge assembly according to the present disclosure;

### DETAILED DESCRIPTION OF PREFERRED EMBODIMENT(S)

According to the present disclosure, advantageous filter cartridge assemblies and methods for manufacture are set forth. The filter cartridge assemblies include membranes fabricated from materials such as nylon, polyethersulfone (PES) and/or polyvinylidene fluoride (PVDF) that maintain thorough wetting through the end cap bonding process. The filter cartridge assemblies typically includes a pleated microporous filter media and polypropylene end caps. The pleated microporous filter media is treated with a hydrophilic polymeric solution or dispersion at the ends thereof prior to contact with molten polypropylene end caps The treated filter media, once bonded with the polypropylene end caps, may be integrity tested in water.

The disclosed filter cartridge assemblies generally include a cylindrical filter element defining an outer periphery, an inner periphery and opposed end surfaces, a perforated cage operatively associated with the outer periphery of the filter element, a perforated core operatively associated with the inner periphery of the filter element and having opposed ends and a predetermined length, and a polypropylene end cap operatively associated with each of the opposed end surfaces of the filter element and bonded to each end of the core. Preferably, the end caps are either chemically or physically bonded to the core, so that the core functions as the backbone of the cartridge assembly.

The use of polypropylene in membrane filter constructions is well accepted as a material that provides sufficient strength; cleanliness; and bonding properties, in the assembly of membrane filter devices. Filtration membranes made of nylon based polymers, polyethersulfone (PES) and/or polyvinylidene fluoride (PVDF) are also well accepted as filter media which provide sufficient water wettability; strength; cleanliness; and bonding properties. However, when such membranes are bonded to polypropylene, through the heating of the polypropylene to a molten state such that the membrane is allowed to penetrate into the molten polypropylene, the complete and thorough wetting of the membrane has heretofore been compromised.

As used herein, the term “Wettability” refers to the ability of a filter device to be wet with water. The term “Wettability Test,” as used herein, means that a filter device is flushed with deionized water at 3 gallons per minute (GPM) for ten (10) minutes with no back pressure. Integrity is then measured in the form of a forward flow diffusion test. The filter is subjected to a specific test pressure and the air flow on the downstream side of the filter device is measured with a flow meter. Acceptable wettability typically constitutes an air flow value less than ten (10) cc/min, but would ideally be between about three (3) and five (5) cc/min. Devices that do not wet well have elevated diffusion values (e.g., 10 to 50 cc/min) and those that do not wet at all have even greater diffusion values (e.g., 50 to 100 cc/min).

Use of the term “microporous membrane” herein is intended to encompass microporous membranes having the ability to retain particles in the size range of from about 0.01 or smaller to about 10.0 microns and higher.

Microporous membranes according to the present disclosure are hydrophilic. By the use of the term “hydrophilic,” it is meant a material or membrane that adsorbs or absorbs water. Generally, such hydrophilicity is enhanced in the presence of a sufficient amount of hydroxyl (OH—), carboxyl (—COOH), amino (—NH₂) and/or similar functional groups on the surface of the membrane. Additionally, hydrophilicity is enhanced by micro textural phenomena, as described by Knight, Gryte & Hazlett. Such groups assist in the adsorption and/or absorption of water onto the membrane. Such hydrophilicity is particularly useful in the filtration of aqueous fluids.

Exemplary microporous membranes according to the present disclosure are produced from nylon. The term “nylon” is intended to embrace film forming polyamide resins including copolymers and terpolymers which include the recurring amido grouping and blends of different polyamide resins. Preferably, the nylon is hydrolytically stable. This might be achieved by various means such as increasing the number of amino end groups as disclosed in U.S. Pat. No. 5,458,782 to Hou et. al., the contents of which are incorporated by reference herein, or increasing the molecular weight of the nylon or by adding antioxidants to the nylon.

Generally, nylon and polyamide resins are copolymers of a diamine and a dicarboxylic acid, or homopolymers of a lactam and an amino acid, and they vary widely in crystallinity or solid structure, melting point, and other physical properties. Preferred nylons for use in fabricating microporous membranes according to the present disclosure include copolymers of hexamethylene diamine and adipic acid (nylon 66), copolymers of hexmethylene diamine and sebacic acid (nylon 610), homopolymers of polycaprolactam (nylon 6) and copolymers of tetramethylenediamine and adipic acid (nylon 46). These preferred polyamide resins have a ratio of methylene (CH₂) to amide (NHCO) groups within the range of about 4:1 to about 8:1. Nylon polymers are available in a wide variety of grades, which vary appreciably with respect to molecular weight, within the range from about 15,000 to about 42,000 (number average molecular weight) and in other characteristics.

A highly preferred species of the units composing the polymer chain is polyhexamethylene adipamide, i.e. nylon 66, having molecular weights above about 30,000. Particularly preferred microporous membrane embodiments according to the present disclosure are devoid of charge modifying agents. Polymers free of additives are generally preferred, but the addition of antioxidants, surface active agents, or similar additives may have benefit under some conditions.

As used herein, a “microporous membrane” is a porous solid containing microporous interconnecting passages that extend from one surface to the other. These passages generally provide tortuous tunnels or paths through which a liquid being filtered must pass. Any particles contained in this liquid that are larger than the pores are either prevented from entering the microporous membrane or are trapped within the pores of the microporous membrane. Some particles that are smaller than the pores are also trapped or absorbed into the pore structure of the microporous membrane within the tortuous path. The liquid and some particles smaller than the pores pass through the microporous membrane. As noted above, microporous membranes of this type have the ability to retain particles that range in size from about 0.01 or smaller to about 10.0 microns or larger.

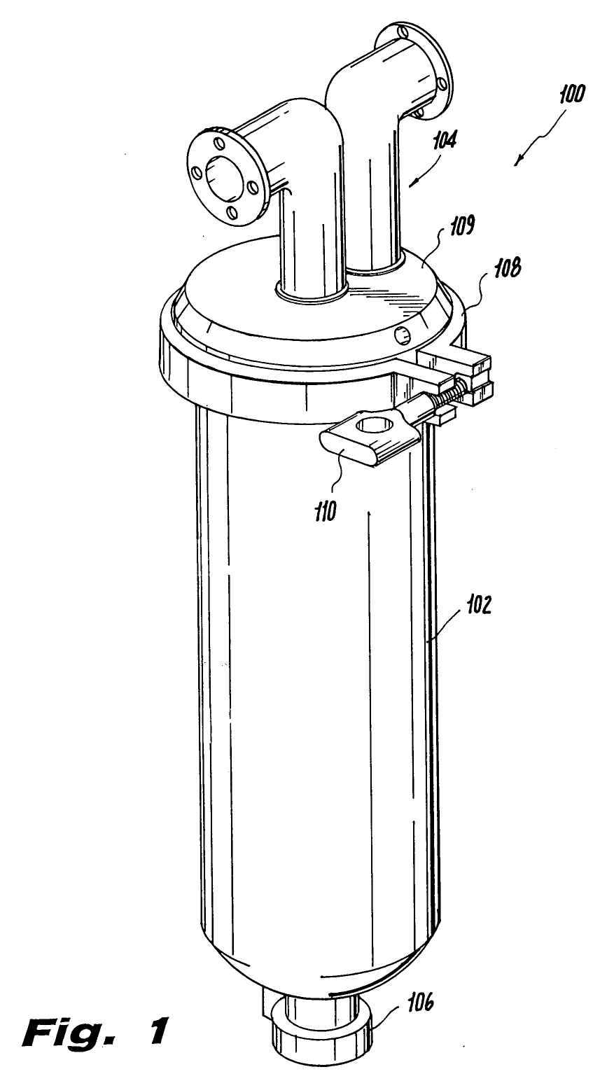

With reference to FIG. 1, an exemplary filter cartridge housing 100 is depicted that includes a cylindrical housing body 102, a T-head 104 and a lower port 106. Cap 109 is detachably secured to housing body 102 by expandable bracket 108. Threaded member 110 may be tightened to fix bracket 108 onto cap 109, thereby securing cap 109 to housing body 102. Conversely, the interior of cartridge housing 100 may be accessed by untightening threaded member 110, thereby releasing bracket 108 and permitting removal of cap 109 from housing body 108. The operation and use of filter cartridge housings of the type depicted in FIG. 1 within conventional filtering applications are well known, and will not be described herein.

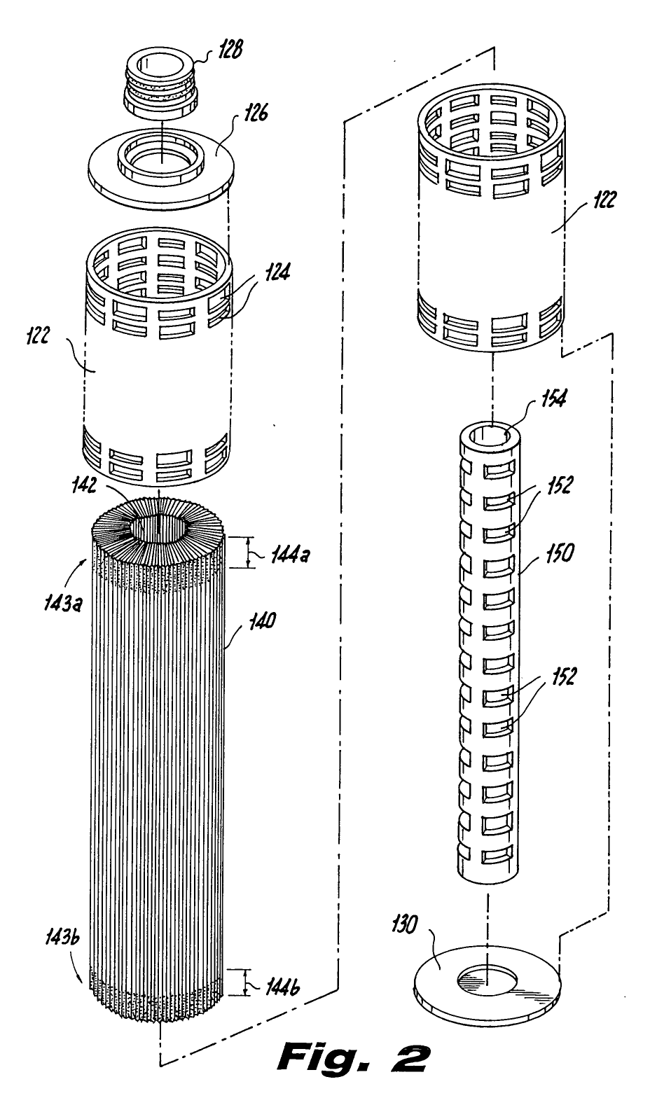

Turning to FIG. 2, exemplary components positioned within filter cartridge housing 100 according to the present disclosure are depicted. Filter cartridge 120 includes a perforated cage 122 (shown in two sections for purposes of the exploded view of FIG. 2). Perforations 124 are generally rectangular in shape and relatively evenly spaced across the surface of cage 122, although other perforation shapes, spacings and dimensions are contemplated, as are known in the art. A polypropylene end cap 126 and adapter 128 are deployed at a first end of cage 122, and a second polypropylene end cap 130 is deployed at an opposite end of cage 122. Adapter 128 is typically bonded or otherwise fixedly joined to end cap 126. Additional components may be employed with end cap 130, as are known in the art, e.g., a spear, closed cap, or the like.

When assembled within cartridge housing 100, cage 122 abuts and is generally joined to end caps 126, 128. The outer diameter of cage 122 and the inner diameter of cartridge housing body 102 define a flow passage to facilitate flow of fluid to be filtered within filter cartridge assembly 100, as is known in the art.

With further reference to FIG. 2, an elongated filter element 140 is deployed within cage 122. The exemplary filter element 140 depicted in FIG. 2 is a pleated membrane filter element defining a central cylindrical opening 142 and a plurality of longitudinally extending pleats. Filter element 140 typically has at one least media layer, an upstream support material and a downstream support material. Depending upon the degree of filter surface area desired for a particular filtration application, the pleats of filter element 140 may be configured as radial pleats, w-pleats or spiral pleats, each of which is well known in the art. As noted above, filter element 140 may be advantageously fabricated from materials such as nylon, polyethersulfone and/or polyvinylidene fluoride.

An elongated perforated cylindrical core 150 is positioned within cylindrical element 142 of filter element 140. Perforations 152 are formed in core 150 to permit passage of filtered fluid to the cylindrical interior passage 154 defined within core 150. Exemplary core 150 includes spaced, substantially rectangular perforations 152 formed in the body of core 150. Alternative core configurations may be employed in filter cartridge assemblies according to the present disclosure, as would be apparent to persons skilled in the art.

Filter element 140 includes first and second end surface regions 143a, 143b. The axial lengths or dimensions of first and second end surface regions 143a, 143b are generally approximately the same, and are selected so as to roughly correspond to the overlap of end caps 126, 230 in connection with the bonding of the end caps thereto. Hydrophilic polymeric surface treatments 144a, 144b are provided on end surface regions 143a, 143b. Polymeric surface treatments 144a, 144b are typically applied to end surface regions 143a, 143b as a solution or dispersion.

Multiple polymeric solutions or dispersions are contemplated for use according to the present disclosure. Preferred hydrophilic polymeric surface treatments include polyvinyl alcohol (e.g., MICA™ M1000), polyethyleneimine (e.g., MICA™ A131X), a combination of 1-4 butanediol diglycidyl ether (e.g., Shell Heloxy 67) and an ethylene amine (e.g., tetraethylenepentamine (TEPA) from Dow Chemical Company), and quaternary amine polyepichlorohydrin (e.g., Ciba Specialty Chemicals, Resicart E). Each of the foregoing polymeric surface treatments result in an improvement in the wetting characteristics of the treated filter device. The polymeric surface treatments chemically link to the surface of the filter element in the opposed end surface regions. In addition, the foregoing hydrophilic polymeric surface treatments do not occlude the pores of the filter element, thereby ensuring optimal filtration performance thereof.

Thus, with further reference to the foregoing polymeric surface treatments, a polymeric dispersion material that has been shown to successfully provide a thorough wet-out of a nylon membrane and polypropylene bond is a modified polyethyleneimine dispersion (MICA A-131-X). This polymeric dispersion is water based, so it is readily adsorbed into the nylon membrane's pore structure. Another polymeric dispersion shown to provide thorough wet-out is a water based dispersion of polyvinyl alcohol (MICA M-1000). However, these two materials do not fulfill the “linking agent” requirement of the present disclosure and are therefore disadvantageously extracted out of the filter after rinsing. A further polymeric solution found to provide thorough wet-out is a water based resin, such as Resicart E or Heloxy 67 materials. These solutions have demonstrated the added benefit of actively bonding to the nylon and not rinsing off (creating additional extractions), presumably due to the presence of epoxy groups which covalently bond to the nylon carboxyl and amine groups. The disclosed advantageous polymer dispersions and solutions have been shown not to interfere with the membrane's porous structure through the occlusion of pores.

However, it is noteworthy that the MICA™ materials have been found to impart a dark yellow color to the end caps of the filter device and also exhibit elevated extractable materials that may leach off the treated device. MICA materials only fulfill the “hydrophilicity” requirements of the present disclosure and do not contain or impart a linking functionality to link them permanently to the membrane. Accordingly, a quaternary amine polyepichlorohydrin material, e.g., Resicart E, which imparts both hydrophilicity and a linking functionality is a currently preferred hydrophilic polymeric surface treatment for use according to the present disclosure.

After application of the hydrophilic polymeric surface treatment to the membrane, the membrane is dried and assembled in a normal manner through the bonding of polypropylene to the membrane. With the application of the polymeric solution to the filter device's bond regions, the membrane has been found to advantageously thoroughly wet-out. In addition, treated membranes according to the present disclosure maintain thorough wetting when brought into contact with molten polypropylene during the bonding process, and provide a pleated filter device that is integrity testable in water.

According to the present disclosure, advantageous methods for fabricating a filter cartridge with polypropylene end caps are provided. According to a first exemplary fabrication method, a cylindrical filter element is provided that defines an outer periphery, an inner periphery and opposed end surface regions. A hydrophilic polymeric surface treatment is applied to the opposed end surface regions of the filter element. The polymeric surface treatment undergoes cross linking and chemically links to the surface of the filter element in the opposed end surface regions. Polypropylene end caps are bonded to the surface treated opposed end surface regions of the cylindrical filter element. The filter cartridge fabricated according to the disclosed method may be advantageously integrity tested in water.

According to the disclosed exemplary method of fabrication, the hydrophilic polymeric surface treatment may be effected using a polymeric solution or dispersion that includes a polymeric material typically selected from polyvinyl alcohol, polyethyleneimine, a combination of 1-4 butanediol diglycidyl ether and ethylene amine, and a quaternary amine polyepichlorohydrin. The polymeric surface treatment imparts hydrophilicity and includes a linking functionality to ensure appropriate bonding to the filter element. The cylindrical filter element is typically pleated and finds utility in a variety of industrial and clinical filtration applications. The filter element is porous and the hydrophilic polymeric surface treatment is non-occlusive with respect to the pores of the filter element. Application of the hydrophilic polymeric surface treatment may be effected by dipping the opposed end surface regions in a hydrophilic polymeric solution or dispersion and curing the hydrophilic polymeric surface treatment.

According to a further exemplary fabrication method of the present disclosure, a filter cartridge element is manufactured by applying a hydrophilic polymeric surface treatment to opposed end surface regions of filter element roll stock. The hydrophilic polymeric surface treatment is cured on the opposed end surface regions, such that the polymeric surface treatment undergoes cross linking and chemically links to the surface of the filter element roll stock in the opposed end surface regions.

In an exemplary embodiment, the hydrophilic polymeric surface treatment is applied to limited end regions of the roll stock. In some applications, it is desired to trim the roll stock in connection with cartridge fabrication. In such application, it is generally desirable to apply the disclosed polymeric surface treatment over regions that extend about one inch from each edge, thereby accommodating edge trimming of about 12 inch. In instances where edge trimming is not contemplated/required, a lesser degree of surface treatment may be undertaken, e.g., over a region extending about ½ to 3/4 inches from each edge.

A cylindrical nylon filter element is formed using the nylon filter element roll stock, with the filter element defining an outer periphery, an inner periphery and opposed end surfaces. The cured hydrophilic polymeric surface treatment is positioned at the opposed end surfaces. Polypropylene end caps are bonded to the opposed end surfaces of the cylindrical filter element; and the filter element may be integrity tested in water.

According to the disclosed exemplary fabrication method, the hydrophilic polymeric surface treatment is typically effected using a polymeric solution or dispersion that includes a polymeric material selected from polyvinyl alcohol, polyethyleneimine, a combination of 1-4 butanediol diglycidyl ether and ethylene amine, and a quaternary amine polyepichlorohydrin. The cylindrical filter element is generally formed by pleating of the filter element roll stock. The filter element is porous and the hydrophilic polymeric surface treatment is advantageously non-occlusive with respect to the porosity of the nylon filter element.

When applying the hydrophilic polymeric surface treatment to roll stock, apparatus such as pinch rollers, slot dies, a sprayer system, and combinations thereof, may be advantageously utilized. The hydrophilic polymeric surface treatment is generally cured by exposing the opposed end surface regions to heat, e.g., using an infrared heater, a convection oven, and combinations thereof.

To assist those of ordinary skill in the art to which the subject matter of the present disclosure appertains in understanding how to construct and use the disclosed filter cartridge assemblies, the following illustrative examples are provided. However, the present application is not to be limited to the subject matter of these illustrative examples, either in whole or in part. Rather, the following examples are merely illustrative of exemplary embodiments of the present disclosure and are non-limiting in nature.

### EXAMPLE 1

### Preparation of Surface Treatment Formulation

An exemplary formulation for use in surface treatment of filter cartridges according to the present disclosure was prepared at the following weight percentages:

| | Weight/ |
|---|---|
| Component | Weight Percent |
| Tetraethylenepentamine (TEPA) [Dow Chem. Co.] | 0.05% |
| Sodium Hydroxide (5N) | 2.00% |
| pH stabilized quaternary amine | 16.00% |
| polyepicholorhydrin resin (Resicart E) (resin | |
| supplied by Ciba-Geigy @ approx. 20% solids) | |
| Deionized (DI) water | 81.05% |

The foregoing components were mixed in solution to form a surface treatment for use in treating filter cartridges according to the present disclosure.

### EXAMPLE 2

### Process for Chemically Modifying Edges of a Cartridge

A filter device is constructed by pleating a filter media with upper and lower support materials. The pleated media is then sealed at the edges to form a cylindrical shaped pack which may be inserted into an outer cage. Alternatively, the cylindrical shaped pack may be surface treated (as described below) before insertion into an outer cage. The sealing of the edges may be accomplished by ultrasonic or heat sealing methods. The filter may then be chemically modified at the ends according to the present disclosure. Alternatively, a core may be inserted as a downstream support before chemically modifying the ends according to the present disclosure. Chemical treatment is performed prior to capping the filter device. Capping is typically achieved by typical melt bonding and potting processes.

A surface treatment formulation prepared according to Exhibit 1 is dispensed into a stainless steel or Teflon tooling that is dimensioned and configured to fit or receive the end of a cartridge. The dispensed amount is proportional to the area of filter media to be coated, based on the desired treatment level. According to this exemplary embodiment, the surface treatment is at a level of approximately 0.15 ml/in² (solution/media to be treated). One end of the cartridge is lowered into the solution and the solution wicks up into the media of the filter. The filter is then removed from the tooling, additional solution is dispensed into the tooling, and the other side of the filter is lowered into the solution. After both edges have been coated, the filter is placed in a drying oven at 80° C. until the edges are fully dried.

### EXAMPLE 3

### Surface Treatment Formulations for Use in Subsequent Examples

The following formulations were prepared for use in surface treatment testing on filter cartridges according to the present disclosure (weight/weight %):

| Formulation | Component A | Component B | Component C | Component D |
|---|---|---|---|---|
| “Resicart E 3%” | Resicart E-16% | DI water-81.05% | NaOH (5N)-2% | TEPA-0.05% |
| “Resicart E 1.5%” | Resicart E-8% | DI water-87.05% | NaOH (5N)-2% | TEPA-0.05% |
| “Resicart E 0.75%” | Resicart E-4% | DI water-91.05% | NaOH (5N)-2% | TEPA-0.05% |
| “Heloxy 67” | Heloxy 67*-0.66% | DI water-84.14% | Methanol-15.06% | TEPA-0.14% |
| “MICA A131x 100%” | MICA A131x^{†}-100% | | | |
| “MICA A131x 25%” | MICA A131x^{†}-25% | DI water-75% | | |
| “MICA A131x 10%” | MICA A131x^{†}-10% | DI water-90% | | |
| “MICA A131x 1%” | MICA A13lx^{†}-1% | DI water-99% | | |
| “MICA M1000” | MICA M1000^{‡}-100% | | | |

*Heloxy 67 is 1-4 butanediol diglycidyl ether (supplied by Shell); alternatively, Epi-Rez 5022 (Ciba-Geigy) may be employed.
^{†}MICA A131x is a water based, modified polyethlenimine dispersion supplied by the MICA Corporation.
^{‡}MICA M1000 is a water based, polyvinyl alcohol (PVOH) supplied by the MICA Corporation.

### EXAMPLE 4

### Exemplary Drying Conditions for 10″ Filter Cartridge

Exemplary drying conditions that are effective for drying surface treated 10″ diameter filter cartridges according to the present disclosure are summarized in the following table. While the drying conditions set forth in the following table are not to be understood to be “optimum” or “essential” drying conditions, they are representative of drying conditions that have been demonstrated to be effective.

| | Nature of Heat | | Drying | Drying |
|---|---|---|---|---|
| Heat Source | Application | Equipment | Temp. | Time |
| Hot Air | Entire Cartridge | Convection Oven | 170° F. | 3.5 hrs. |
| Hot Air | Edges Only | Hot Air Gun | 800° F. | 10 min. |
| Infrared (IR) | Edges Only | Quartz IR Heaters | 800° F. | 12 min. |
| Heat | | | | |

Of note, if lower temperatures and/or shorter times than those disclosed in the foregoing table are utilized, there is a risk that the edges of the cartridges may not fully dry. A failure to fully dry the cartridge edges creates pockets of moisture that are evaporated during the final end capping process. These evaporated pockets cause “bubbles” in the end cap that produce localized failures at the end cap. Failures can be detecting using a Reverse Integrity Test.

A Reverse Integrity Test (or Reverse Bubble Test) involves submersion of a filter in a liquid (typically water, 25% tert-butyl alcohol (TBA) or 60% isopropyl alcohol (IPA)). A pressure (air or alternative gas, e.g., nitrogen, SF₆) is applied from the downstream side of the filter. The pressure is slowly ramped until a steady stream of bubbles is detected. If no bubbles are visible before the bubble point pressure is reached, the filter is integral. If a steady stream of bubbles can be visualized prior to reaching the media's bubble point, the filter has a defect. The location of the defect can be noted and further failure analysis can be conducted to determine the root cause of the failure.

Higher temperatures and/or longer times can cause damage to the filter media. Alternate materials of construction, e.g., media other than nylon, may require more or less heat and/or heating time to effect the desired level of drying, depending on the specific materials of construction employed in fabricating the filter.

### EXAMPLE 5

### Drying Studies

Additional drying studies were performed to evaluate drying conditions that are effective for drying surface treated filter cartridges according to the present disclosure, as set forth in the following table.

| Heating Process | Temperature | Drying Time | Integrity of Samples* |
|---|---|---|---|
| IR Heater | 800° F. | 1 min | No |
| IR Heater | 800° F. | 2 min | No |
| IR Heater | 800° F. | 12 min | Yes |
| IR Heater | 600° F. | 1 min | No |
| IR Heater | 600° F. | 2 min | No |
| Air Gun | 800° F. | 6 min | No |
| Air Gun | 800° F. | 8 min | No |
| Air Gun | 800° F. | 10 min | Yes |
| Convection Oven | 170° F. | 2.0 hrs. | No |
| Convection Oven | 170° F. | 3.5 hrs. | Yes |

*Sample integrity was determined by performing a Reverse Integrity Test (described above) @ 12 psi.

As is apparent from the data reported in the foregoing table, certain drying conditions were determined to be more effective than others for purposes of drying filter cartridges treated according to the present disclosure, while simultaneously maintaining sample integrity (as measured by Reverse Integrity Tests).

### EXAMPLE 6

### Wettability Responses of Various Formulations

A “diffusive flow integrity” test at an appropriate test pressure is performed following every wetting cycle. As used herein, the procedure for performing a diffusive flow integrity test is described in the text entitled Membrane Filtration by Brock (1983) at page 58, the content of which is hereby incorporated by reference. Each wetting cycle is intended to be a progressively more aggressive procedure to wet the filter. As the procedure is made more aggressive, the filter should wet better and; therefore, have a lower diffusive flow. Since the water does not fully wet some of the filters, a “bubble point” test in alcohol is performed at the conclusion of the wettability test to ensure that all filters used in the study are integral and have similar bubble points. As used herein, the procedure for performing a bubble point test is described in the text entitled Membrane Filtration by Brock (1983) at pages 48-58, the content of which is hereby incorporated by reference.

As used herein, “system return pressure” refers to the pressure applied downstream of a filter device that creates a restrictive condition on flow. This parameter can be increased to produce a more aggressive wetting condition. Also, as used herein, the term “wettability” refers to the ability of a filter device to fully wet with water and a “wettability test” is a test that is performed with increasingly aggressive wetting conditions to determine the ability of a given filter to fully wet with water. After each wetting condition, a diffusive flow integrity test is performed at a given test pressure. Wetting conditions start with a “static soak” condition and then move into dynamic exposure to water. The dynamic conditions are made more aggressive by increasing the amount of system return pressure applied downstream of the filter. Typically, after performing a wettability test, the filter's integrity is confirmed with a bubble point test in an alcohol solution (because alcohol fully wets most filters).

All dynamic testing was performed at 3 gallons per minute (GPM) for 10 minutes with corresponding return pressure listed in the following tables. As noted in the following tables, typical return pressures were 0 psi, 5 psi, 25 psi and 50 psi.

Wettability Response of a Polypropylene Capped Filter
Treated With Resicart E Forward Flow Integrity Test
Data @ 30 psi (sccm)

| | | Dynamic Flow Condition | | | Final |
|---|---|---|---|---|---|
| | Static | System Return Pressure | | | Bubble Point (psi) |
| Treatment | Soak | 0 psi | 15 psi | 25 psi | in 60/40 IPA/H₂0 |
| Control (none) | | | | | |
| 1 | 100 | 100 | 100 | 100 | 31.0 |
| 2 | 100 | 100 | 100 | 100 | 30.9 |
| 3 | 100 | 100 | 100 | 100 | 35.4 |
| Resicart E 1.5% | | | | | |
| 1 | 8.4 | 3.7 | 3.5 | 3.3 | 29.9 |
| 2 | 7.6 | 5.1 | 4.9 | 4.7 | 32.6 |
| 3 | 5.3 | 3.6 | 3.4 | 3.3 | 36.9 |

Wettability Response of a Polypropylene Capped Filter
Treated With Resicart E Forward Flow Integrity Test
Data @ 45 psi (sccm)

| | | Dynamic Flow Condition | | | Final |
|---|---|---|---|---|---|
| | Static | System Return Pressure | | | Bubble Point (psi) |
| Treatment | Soak | 0 psi | 15 psi | 25 psi | in 60/40 IPA/H₂0 |
| Control (none) | | | | | |
| 1 | 100 | 100 | 100 | 100 | 24.4 |
| 2 | 100 | 100 | 100 | 85.5 | 24.2 |
| Resicart E 0.75% | | | | | |
| 1 | 58.4 | 26.3 | 10.0 | 6.9 | 24.4 |
| 2 | 63.9 | 34.0 | 13.2 | 9.0 | 24.1 |
| 3 | 66.3 | 33.0 | 6.9 | 6.3 | 25.3 |

| | | Dynamic Flow Condition | | | Final |
|---|---|---|---|---|---|
| | Static | System Return Pressure | | | Bubble Point (psi) |
| Treatment | Soak | 0 psi | 15 psi | 25 psi | in 60/40 IPA/H₂0 |
| Resicart E 1.5% | | | | | |
| 1 | 9.7 | 6.2 | 7.6 | 5.2 | 23.8 |
| 2 | 33.9 | 14.0 | 7.8 | 6.0 | 24.0 |
| 3 | 17.4 | 9.8 | 6.1 | 4.8 | 24.4 |
| Resicart E 3.0% | | | | | |
| 1 | 7.5 | 4.7 | 3.5 | 3.3 | 25.2 |
| 2 | 4.6 | 3.8 | 3.7 | 3.3 | 23.5 |
| 3 | 4.6 | 3.9 | 3.5 | 3.3 | 25.5 |

Wettability Response of a Polypropylene Capped Filter
Treated with MICA Forward Flow Integrity Test
Data @ 30 psi (sccm)

| | | Dynamic Flow Condition | | | Final |
|---|---|---|---|---|---|
| | Static | System Return Pressure | | | Bubble Point (psi) |
| Treatment | Soak | 5 psi | 15 psi | 50 psi | in 60/40 IPA/H₂0 |
| Control (none) | | | | | |
| 1 | 100 | 100 | 100 | 26.0 | 17.6 |
| 2 | 100 | 100 | 100 | 31.2 | 17.7 |
| 3 | 100 | 100 | 100 | 42.6 | 16.5 |
| Mica A131x | | | | | |
| (100%) | | | | | |
| 1 | 9.8 | 2.9 | 2.8 | 2.6 | 17.8 |
| 2 | 100 | 14.3 | 2.7 | 2.5 | 17.5 |
| 3 | 100 | 4.4 | 2.6 | 2.3 | 16.9 |

| | | Dynamic Flow Condition | | | Final |
|---|---|---|---|---|---|
| | Static | System Return Pressure | | | Bubble Point (psi) |
| Treatment | Soak | 0 psi | 15 psi | 25 psi | in 60/40 IPA/H₂0 |
| Mica M1000 | | | | | |
| 1 | 100 | 14.3 | 3.6 | 2.1 | 16.6 |
| 2 | 17.8 | 3.9 | 2.6 | 2.1 | 16.7 |
| 3 | 19.1 | 3.4 | 2.6 | 2.1 | 17.8 |

Wettability Response of a Polypropylene Capped Filter
Treated With MICA A131x Forward Flow Integrity Test
Data @ 30 psi (sccm)

| | | Dynamic Flow Condition | | Final |
|---|---|---|---|---|
| | Static | System Return Pressure | | Bubble Point (psi) |
| Treatment | Soak | 5 psi | 15 psi | in 60/40 IPA/H₂0 |
| Control (none) | | | | |
| 1 | 100 | 100 | 100 | 16.2 |
| 2 | 100 | 100 | 100 | 16.1 |
| Mica A131x (25%) | | | | |
| 1 | 56.2 | 18.7 | 12.2 | 16.8 |
| 2 | 42.9 | 12.5 | 6.9 | 16.8 |
| 3 | 17.2 | 4.3 | 3.4 | 16.6 |
| Mica A131x (10%) | | | | |
| 1 | 100 | 65.6 | 15.5 | 17.3 |
| 2 | 100 | 100 | 77.0 | 16.2 |
| 3 | 100 | 31.7 | 10.8 | 17.1 |
| Mica A131x (1%) | | | | |
| 1 | 100 | 100 | 100 | 17.2 |
| 2 | 100 | 100 | 100 | 16.8 |

Wettability Response of a Polyester Capped Filter
Treated With Various Materials Forward Flow
Integrity Test Data @ 35 psi (sccm)

| | | Dynamic Flow | | |
|---|---|---|---|---|
| | | Condition System | | |
| | Static | Return Pressure | | Final Bubble Point |
| Treatment | Soak | 5 psi | 15 psi | (psi) in 60/40 IPA/H₂0 |
| Control (none) | | | | |
| 1 | 9.6 | 3.9 | 3.0 | 16.4 |
| 2 | 29.2 | 10.1 | 5.0 | 15.1 |
| 3 | 13.7 | 6.5 | 4.1 | 16.3 |
| Mica A131x (100%) | | | | |
| 1 | 19.2 | 3.8 | 3.1 | 16.1 |
| 2 | 4.6 | 3.0 | 4.0 | 16.0 |
| 3 | 4.6 | 5.7 | 4.9 | 16.2 |
| Mica M1000 | | | | |
| 1 | 3.4 | 2.7 | 3.2 | 15.9 |
| 2 | 3.7 | 3.3 | 1.7 | 15.8 |
| 3 | 4.0 | 3.8 | 3.6 | 16.0 |
| Heloxy 67 | | | | |
| 1 | 4.0 | 3.3 | 2.5 | 15.6 |
| 2 | 4.2 | 3.0 | 1.7 | 16.0 |
| 3 | 8.4 | 2.7 | 2.7 | 16.1 |

A benefit has been observed in using end caps made of polyester materials over polypropylene; however, polypropylene is preferred in the industry for chemical stability. Even in systems that include polyester caps, chemically modifying the edges of the media according to the present disclosure still provides advantageous wetting benefits.

### EXAMPLE 7

### Extraction Response from MICA A131x and Resicart E Samples

A series of extraction response tests were performed using treated filter cartridges. The results of such tests are summarized in the following table.

| | Total Non-Volatile Gravimetric Extractables in |
|---|---|
| Treatment | H₂0 (mg) Per 10″ Filter |
| Control (none) | |
| 1 | 19.5 |
| 2 | 22.8 |
| Mica A131x (100%) | |
| 1 | 313.7 |
| 2 | 203.5 |
| Resicart E (3.0%) | |
| 1 | 23.9 |
| 2 | 20.9 |
| 3 | 19.0 |
| 4 | 34.0 |
| 5 | 33.0 |

Based on the foregoing test results, Resicart E provides a benefit with respect to extraction levels. In fact, the amount of extraction from the Resicart E samples is very similar to the baseline level obtained from untreated controls. This advantageous performance may be due to epoxy functionality present in the Resicart E material, which allows for more stable chemical binding between the modifying agent and the filter media. Substances that exhibit a higher binding strength will also exhibit less mobility and, therefore, will have lower levels of extractable substances.

Chemical substances having a high level of hydrophilic domains in their structures and a binding affinity for the filter media should theoretically work in cartridge treatment applications according to the present disclosure. In addition, it is believed that the disclosed materials bind specifically to the surface of the filter media but do not in any way obstruct the pore structure. Flow channels in the media remain accessible to the solution being filtered. Bubble points of filter medias were tested to show this phenomenon. Obstruction of the pore structure of the media would theoretically result in a large increase in bubble point values or, if the pore structure were completely blocked, the inability to measure the bubble point.

### EXAMPLE 8

### Bubble Point Response of Treated Samples vs. Controls*

Bubble points were determined on 47 mm discs in 60/40 IPA/H₂O, and the results are reported in the following table.

| | Sample Bubble Point (psi) in 60/40 IPA/H₂0 |
|---|---|
| Treatment | Per 10″ Filter |
| Control (none) | |
| 1 | 14.4 psi |
| 2 | 15.4 psi |
| 3 | 14.2 psi |
| Mica A131x (100%) | |
| 1 | 15.4 psi |
| 2 | 15.1 psi |
| 3 | 15.2 psi |
| Mica M1000 | |
| 1 | 13.8 psi |
| 2 | 14.6 psi |
| 3 | 16.9 psi |

* The disclosed samples were saturated with the polymeric surface treatment, as opposed to edge treatment, based on the limited sample size.

Thus, according to the present disclosure, advantageous filter cartridge assemblies are provided that facilitate filtration in a wide range of applications and utilities. Further aspects, features and advantages associated with the disclosed filter cartridge assemblies and their methods of manufacture will be apparent to persons skilled in the art from the disclosure provided herewith.

Although filter cartridge assemblies of the present disclosure have been described with reference to exemplary embodiments thereof, the present disclosure is not to be limited to the specifics of the disclosed embodiments, but is to be broadly understood in the context of filter cartridge assemblies for use in filtering fluid systems. The disclosed embodiments are merely illustrative, and not limitative, of the scope of the present invention, and changes, modifications and/or variations may be utilized without departing from the spirit or scope of the present invention.

1. A filter cartridge assembly comprising:
a) a cylindrical filter element defining an outer periphery, an inner periphery and opposed end surface regions;
b) a hydrophilic polymeric surface treatment in said opposed end surface regions of said filter element, said polymeric surface treatment being chemically linked to the surface of the filter element in said opposed end surface regions; and
c) polypropylene end caps bonded to said opposed end surface regions of said cylindrical filter element;
wherein said filter element is integrity testable in water.

2. A filter cartridge assembly according to claim 1, wherein said hydrophilic polymeric surface treatment is effected using a polymeric solution or dispersion that includes a polymeric material selected from the group consisting of polyvinyl alcohol, polyethyleneimine, a combination of 1-4 butanediol diglycidyl ether and ethylene amine, and a quaternary amine polyepichlorohydrin.

3. A filter cartridge assembly according to claim 1, wherein said cylindrical filter element is fabricated from a material selected from the group consisting of nylon, polyethersulfone (PES) and/or polyvinylidene fluoride (PVDF).

4. A filter cartridge assembly according to claim 1, wherein said filter element is porous and wherein said hydrophilic polymeric surface treatment is non-occlusive with respect to said porosity of said filter element.

5. A method for fabricating a filter cartridge comprising:
a) providing a cylindrical filter element defining an outer periphery, an inner periphery and opposed end surface regions;
b) applying a hydrophilic polymeric surface treatment to said opposed end surface regions of said filter element, said polymeric surface treatment undergoing cross linking and chemically linking to the surface of the filter element in said opposed end surface regions;
c) bonding polypropylene end caps to said surface treated opposed end surface regions of said cylindrical filter element; and
d) integrity testing said filter element in water.

6. A method for fabricating a filter cartridge according to claim 5, wherein said hydrophilic polymeric surface treatment is effected using a polymeric solution or dispersion that includes a polymeric material selected from the group consisting of polyvinyl alcohol, polyethyleneimine, a combination of 1-4 butanediol diglycidyl ether and ethylene amine, and a quaternary amine polyepichlorohydrin.

7. A method for fabricating a filter cartridge according to claim 5, wherein said cylindrical filter element is fabricated from a material selected from the group consisting of nylon, polyethersulfone (PES) and/or polyvinylidene fluoride (PVDF).

8. A method for fabricating a filter cartridge according to claim 5, wherein said filter element is porous and wherein said hydrophilic polymeric surface treatment is non-occlusive with respect to said porosity of said nylon filter element.

9. A method for fabricating a filter cartridge according to claim 5, wherein said application of said hydrophilic polymeric surface treatment is effected by dipping said opposed end surface regions in a hydrophilic polymeric solution or dispersion and curing said hydrophilic polymeric surface treatment.

10. A method for fabricating a filter cartridge comprising:
a) applying a hydrophilic polymeric surface treatment to opposed end surface regions of filter element roll stock;
b) curing said hydrophilic polymeric surface treatment to said opposed end surface regions, such that said polymeric surface treatment undergoes cross linking and chemically links to the surface of the filter element roll stock in said opposed end surface regions;
c) forming a cylindrical filter element using said filter element roll stock, said filter element defining an outer periphery, an inner periphery and opposed end surfaces with said cured hydrophilic polymeric surface treatment positioned at said opposed end surfaces;
d) bonding polypropylene end caps to said opposed end surfaces of said cylindrical filter element; and
e) integrity testing said filter element in water.

11. A method for fabricating a filter cartridge according to claim 10, wherein said hydrophilic polymeric surface treatment is effected using a polymeric solution or dispersion that includes a polymeric material selected from the group consisting of polyvinyl alcohol, polyethyleneimine, a combination of 1-4 butanediol diglycidyl ether and ethylene amine, and a quaternary amine polyepichlorohydrin.

12. A method for fabricating a filter cartridge according to claim 10, wherein formation of said cylindrical filter element includes pleating of said filter element roll stock.

13. A method for fabricating a filter cartridge according to claim 10, wherein said filter element is porous and wherein said hydrophilic polymeric surface treatment is non-occlusive with respect to said porosity of said filter element.

14. A method for fabricating a filter cartridge according to claim 10, wherein said application of said hydrophilic polymeric surface treatment to said opposed surface regions is effected using apparatus selected from the group consisting of pinch rollers, slot dies, a sprayer system, and combinations thereof.

15. A method for fabricating a filter cartridge according to claim 10, wherein said curing of said hydrophilic polymeric surface treatment includes exposing said opposed end surface regions to heat.

16. A method for fabricating a filter cartridge according to claim 15, wherein said heat is supplied by apparatus selected from the group consisting of an infrared heater, a convection oven, and combinations thereof.
